(19) United States
(12) Patent Application Publication
(10) Pub. No.: US 2025/0256636 A1
(43) Pub. Date: Aug. 14, 2025

(54) SAFETY CHOCK

(71) Applicants: Uvaldo ARRAZOLO, Albuquerque, NM (US); Gilbert ARRAZOLO, Albuquerque, NM (US)

(72) Inventors: Uvaldo ARRAZOLO, Albuquerque, NM (US); Gilbert ARRAZOLO, Albuquerque, NM (US)

(21) Appl. No.: 18/436,079

(22) Filed: Feb. 8, 2024

(51) Int. Cl. B60P 7/12; B60P 7/08

(52) U.S. Cl. CPC B60P 7/12; B60P 7/0892

(57) ABSTRACT

A pipe chock made of metal and containing a wedge with a single downwardly depending dunnage attachment surface for attaching to the side of a dunnage is described.

### PRIOR RELATED APPLICATIONS

Not applicable.

### FEDERALLY SPONSORED RESEARCH STATEMENT

Not applicable.

### REFERENCE TO MICROFICHE APPENDIX

Not applicable.

### FIELD OF THE DISCLOSURE

This invention relates generally to a safety chock used to secure loads, especially loads of pipe or other tubular materials.

### BACKGROUND OF THE DISCLOSURE

Transporting pipes on trucks is one of the most commonly employed methods for moving pipes from one location to another. It is practical and efficient, but safely and legally transporting pipes on trucks requires expertise and proper handling to ensure the integrity of the cargo and the safety of others on the road. In fact, pipe handling can be a very dangerous task due to pipe weight, length and the fact that they are round, allowing the load to roll. When handling pipe, the danger area includes the loading or unloading area, the path of travel, the destination, and any area the pipe might travel to if uncontrolled.

The load securement rules were amended in 2006 (71 FR 35833, Jun. 22, 2006). There are specific load securement rules for the following cylindrical loads: 49 CFR § 393.116 Securement of logs; 49 CFR § 393.120 Securement of metal coils; 49 CFR § 393.122 Securement of paper rolls; 49 CFR § 393.124 Securement of concrete pipe.

The transportation of metal and PVC pipe remains under the generic rules as follows: 49 CFR § 393.106 (b) General. Cargo must be firmly immobilized or secured on or within a vehicle by structures of adequate strength, dunnage or dunnage bags, shoring bars, tiedowns or a combination of these. (c) Cargo placement and restraint. Articles of cargo that are likely to roll must be restrained by chocks, wedges, a cradle or other equivalent means to prevent rolling. The means of preventing rolling must not be capable of becoming unintentionally unfastened or loose while the vehicle is in transit.

Although the rule requires the use of chocks of other devices to prevent rolling, there is no guidance the type, number or minimum requirements of the chocks or other anti-rolling devices. As such, there is great variability in implementation of chocks, and the potential for failure. Indeed, every year there are a large number of pipe-related fatalities, many involving loading and unloading pipes from trucks, where the loads can weigh almost 50,000 pounds and a single pipe can easily weigh a ton.

Generally speaking, the pipes are loaded on the top of dunnage—typically a 4×4 length of wood. The pipe is then loaded in one of two methods—the pyramid method or by layering. In pyramid loading the pipes are loaded in a triangular shape with a wide base on a single dunnage layer, tapering with each pipe layer added, and then strapped down with nylon straps. The second method is layering. The first layer of pipe is loaded onto a first layer of dunnage, usually pipes of the same diameter. A second dunnage is placed on top of the first pipe layer and the second dunnage loaded with a second pipe layer. Then a second, third, and fourth layer of pipe is loaded, each pipe layer separated from an adjacent pipe layer by a dunnage layer.

One issue that is peculiar to pipe is the coating of pipe for the petroleum industry. The coating is a very expensive anti-corrosive treatment. Truckers are required to ensure no metal contacts the coated pipe during shipping. As such the pipe cannot be chained and any material used on the pipe, whether dunnage, blocks, or chocks must not allow any metal-to-metal contact with the anti-corrosive coat which would damage it. This further reduces the options for the truck driver for chocking purposes.

Chocks are typically used at each end of the dunnage to stabilize the pipes against lateral movement. Often, truckers use a wooden chock made by sawing a 4×4 or 6×6 block of wood at about a 45-degree angle. However, these chocks wear out very quickly, and can be very unsafe where fast growing, light wood is used as opposed to hard wood. Further, such chocks have very limited lifespan due to the heavy loads and the holes used to nail or screw the chock to the dunnage.

A commercially available chock by Mytee Products (Aurora, OH) is shown in FIG. 1A. It is made of heavy-duty polyethylene, comes in 5- and 8-inch sizes with two or three nail holes, respectively, and is less than 5 dollars. It is recommended to secure the chocks to the dunnage with 2-3 double headed nails, the second head protruding for easier removal.

In more detail, we see chock 100 having an angled pipe interface top surface 103, a dunnage surface or base 105, triangular sides 107 and securing ledge 109 protruding backward from the wedge. Ledge 109 has 2-3 holes 111 into which double headed nails 113 are used to fasten chock 100 to dunnage 11.

However, in use the securing end 109 lies outside of the pipe load 13, wasting 4-6 inches of dunnage 11 space. See FIG. 1B. Further, we have tested these chocks and they fail under a thousand pound load. Thus, although an affordable safety tool, there is room for improvement, especially by increasing strength and durability and in conserving dunnage space.

A more durable chock is described in U.S. Pat. No. 10,549,676 and shown in FIG. 2A-B. This chock is made of metal and has a square slot that fits over the dunnage 11, as shown in FIG. 2B.

In more detail, chock 200 includes a chock front 202 having a chock front opening 204, a chock rear 206 having a chock rear opening 208 (not visible at this angle, but opposite 204), a chock top 210, a chock bottom 212, two chock sides 214 and a chock handle 216. The chock sides 214, bottom 212 and top 210 define a chock cavity 218 that is square in cross section and sized to fit over the dunnage. The chock front 202 includes a chock front upper portion 220 and a chock front lower portion 222, wherein the chock front upper portion 220 includes an interface surface 224 upon which the pipe 13 will be supported and stabilized.

In FIG. 2B we see dunnage 11 fitting through chock cavity 218 when in use to secure a pipe 13. While very strong and secure, this chock is difficult to make and is both very heavy and expensive. Given that dozens of chocks may be needed to secure a load, these chocks are not very practical, and indeed are not even commercially available. In addition, there is variation in the exact measurements of the dunnage, and this can allow for a loose and unsafe fitting over the dunnage if the cavity is too large, or difficulty in inserting the dunnage if exact or too small or if the dunnage surface is rough.

Thus, what is needed in the art are better devices for securing loads that are simple in design and easy to manufacture, easy and quick to install, strong and durable enough for repeat use with thousands of pounds of load, and yet at the same time quite affordable. This invention provides one or more of those needs.

### SUMMARY OF THE DISCLOSURE

The invention herein is a metal chock having a wedge-shaped pipe interface component and a single dunnage securing surface or flange that protrudes downwards from the pipe interface wedge and secures to a single side of the dunnage, rather than its top surface as in most wedge shaped chocks. Having only one securing surface, rather than the 4 dunnage surrounding surfaces of U.S. Pat. No. 10,549,676, it is much simpler, weighs less and is easy to manufacture as well as to install. Due to its simplicity, this chock can be made for less than 10 dollars each.

In addition, we have tested a prototype of the pipe chock made with 3 mm cold rolled steel and compared it against the prior art resin pipe chock as well as home-made wooden chocks. Our testing showed that the resin chock and wooden chocks both fail well below 1000 pounds of pressure, but the metal prototype withstood 5000 pounds, although there was a small amount of deformation of the wedge. Thus, we believe that our device will withstand thousands of uses at 4500 pounds or more, and with thicker steel, better alloys, adding baffles or switching to a solid wedge this can be improved even further.

In one embodiment, the chock comprises a wedge with a single flange mounting surface downwardly depending from the wedge so as to be capable of attachment to the side of a dunnage, not the top of the dunnage, nor surrounding the dunnage as in the above discussed prior art. Preferably, the side surface of the wedge, and the dunnage attachment flange are integral, so there is no weakness at this point, as might be caused by a weld. The chock will have at least 3-6 holes on the side flange allowing either screws, double headed nails or plain nails to be used for fastening to the dunnage, although a larger chock may have even more attachment points. The wedge may be solid, if desired, but is preferably hollow for weight and material cost reasons, although vertical baffles may be used to increase strength. Further, the wedge is preferably closed on all sides for strength and stability, but this is not essential, especially for lighter loads, such as PVC pipes.

In preferred embodiments, the chock is made from a single piece of metal and bent and welded to form the complete chock with hollow fully enclosed wedge. In other embodiments, the chock may be made from more than one piece and welded or bent and welded as needed. In yet other embodiments, the wedge is hollow with vertical support baffles therein, or it may also be solid.

The invention includes any one or more of the following embodiments in any combinations thereof:

-A pipe chock, said pipe chock comprising:
a) a pipe support having a generally right triangular prism shape with an upwardly angled
top, a bottom, a back, a first triangular side and a second triangular side;
b) a single dunnage attachment member downwardly depending from said first triangular
side;
c) said dunnage attachment member having holes therein for fastening said pipe chock to
a side surface of a separate dunnage; and
d) said top supporting a separate tubular member when in use.
-A metal pipe chock, said pipe chock comprising:
a) a metal pipe support having a generally right triangular prism shape with a top, a
bottom, a back, a first triangular side and a second triangular side;
b) said bottom having a front end and a back end opposite said front end and contacting
said back;
c) said bottom sized to fit a width of a separate dunnage;
d) a single metal dunnage attachment member downwardly depending from said first
triangular side and protruding beyond said front end of said bottom;
e) said dunnage attachment member having holes therein for fastening said pipe chock to
a side of said separate dunnage; and
said top supporting a separate tubular member when in use.
-A metal pipe chock, said pipe chock comprising i) a generally right triangular prism shaped
metal wedge component sized to fit over a separate dunnage and ii) a single metal dunnage
attachment surface downwardly depending from said wedge component and having
attachment means thereon for attaching to a side of said separate dunnage.
-A metal pipe chock, said pipe chock comprising i) a generally right triangular prism shaped
metal wedge component sized to fit over a separate dunnage and ii) a single metal dunnage
attachment surface downwardly depending from said wedge component and integral with a
side surface of said wedge and having attachment means thereon for attaching to a side of
said separate dunnage.
Any pipe chock herein described, that comprises metal and wherein said metal is selected from
alloy steel, carbon steel, tool steel, or stainless steel.
Any pipe chock herein described, wherein said pipe chock or a portion thereof is coated with an
anti-rust or resin coating.
Any pipe chock herein described, wherein said pipe chock is cut as a single piece from a sheet
of metal and formed by bending and welding said cut sheet.
Any pipe chock herein described, wherein said pipe chock is cut as a plurality of pieces from a
sheet of metal and formed by bending and/or welding one or more of said plurality of pieces.
Any pipe chock herein described, wherein said pipe chock is cut as a plurality of pieces from a
sheet of metal and formed by bending and/or welding one or more of said plurality of pieces
and wherein a hypotenuse of said first triangular side and said second triangular side is curved
and said top is curved.
Any pipe chock herein described, wherein said top further comprises a layer of resin attached
to an upper surface of said top.
Any pipe chock herein described, wherein said top further comprises a 0.25-1-inch layer of resin
attached to an upper surface of said top, said resin selected from HDPE or nylon.
Any pipe chock herein described, wherein said top and a portion of said first and second
triangular sides comprises a 0.25-1-inch layer of resin, said resin selected from HDPE or nylon
and attached to said pipe chock on said portion of said first and second triangular sides.
Preferably the attachment is via metal screws or bolts.
Any pipe chock herein described, wherein said generally right triangular prism shape is solid,
not hollow.
Any pipe chock herein described, wherein said generally right triangular prism shape is a fully
enclosed hollow shape.
Any pipe chock herein described, wherein said generally right triangular prism shape is hollow
with one or more vertical baffles inside to increase strength.

As used herein, “dunnage” is loose material used to support and protect cargo in a in shipment. In the trucking context, the dunnage is typically a 4×4 or 6×6 board as long as the width of a flatbed (often 102 inches) preferably made of hardwood that is used to lift cargo off the flatbed and secure the cargo in place.

As used herein, a “chock” is a wedge shaped device used to prevent round materials such as wheels and pipes from rolling.

As used herein a “wedge” is a generally right triangular prism shape having five surfaces: two triangular shaped sides, along with a rectangular bottom, rectangular top and a rectangular back.

As used herein a “right triangular prism shape” has 5 faces, 6 vertices and 9 edges, and the back and top are rectangular (having right angles), although some degree of variation in angles can be tolerated in the inventive chock.

A “generally right triangular prism shape,” by contrast, allows some curvature of the top surface and thus the triangular sides have a curved hypotenuse. Preferably the wedge or two triangular shaped sides have a right angle between the base and the back, but some variation of 90° may be tolerated in the inventive chock.

As used herein, the “hypotenuse” is the longest side of a right-angled triangle—the side opposite the right angle. In this context it is the edge that meets the pipe support surface, even where the triangle is not a right angle triangle. A right angle triangle is preferred as conserving the most dunnage space, but the right angle may be reduced (<90°) if desired to provide a wider base on the wedge.

When discussing “top” and “bottom” herein, we refer to the orientation when in correct usage. Thus, the upwardly angled surface is the top surface of the wedge that contacts the pipe when loaded and the bottom surface of the wedge contacts the dunnage. Further, the “back” of the chock is at or near the outer ends of the dunnage, and the “front” end faces both the load and a chock on the opposite end of the dunnage.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed and excludes all additional elements.

The phrase “consisting essentially of” excludes additional material elements, but allows the inclusions of non-material elements, such as instructions for use, labels, additional attachment means for straps, and the like that do not substantially change the nature of the invention.

### BRIEF DESCRIPTION OF THE DRAWINGS

FIG. 1A Prior art resin chock with dunnage securing surface to the outside of the wedge shaped pipe interface component.

FIG. 1B Prior art resin chock secured to dunnage and supporting a pipe. Here the securing surface secures to the top of the dunnage and outside of the pipe load, thus wasting dunnage space.

FIG. 2A Prior art metal chock with dunnage securing surface surrounding the dunnage on all 4 sides.

FIG. 2B Prior art metal chock secured around the dunnage and supporting a pipe.

FIG. 3A Rear view of truck with dunnage and pipe loads.

FIG. 3B Close up detail of circle A from FIG. 3A.

FIG. 3C cross sectional view at line A-A of FIG. 3B showing how the chock attaches to the dunnage.

FIG. 3D Perspective view of the inventive chock.

FIG. 3E Perspective view of the inventive chock from another angle.

FIG. 3F A variation of the pipe chock with a layer of resin on the top surface.

FIG. 3G Another variation of the pipe chock with a layer of resin on the top surface and a portion of the side surface of the wedge, allowing the fasteners to be on the side.

FIG. 3H One possible pattern or template for the chock of FIG. 3A-G when cut as a single piece.

FIG. 4A Perspective side view of a curved pipe chock.

FIG. 4B Flat layout of a pattern that may be used to form the curved chock.

FIG. 5 Steel properties.

FIG. 6 Alloy properties.

FIG. 7A Back end view of a chock with baffles.

FIG. 7B Offset cross sectional view through line 7B-7B of the chock of FIG. 7A strengthened with internal vertical baffles inside hollow wedge.

FIG. 8A Back end view of a solid chock.

FIG. 8B Offset cross sectional view through line 8B-8B of the chock of FIG. 8A showing the entire wedge is solid, rather than hollow.

FIG. 9 Device for chock load testing.

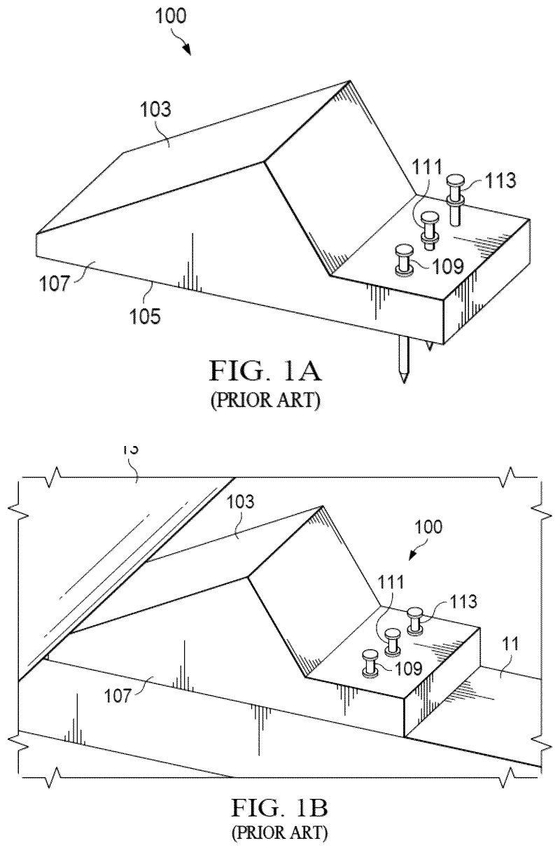

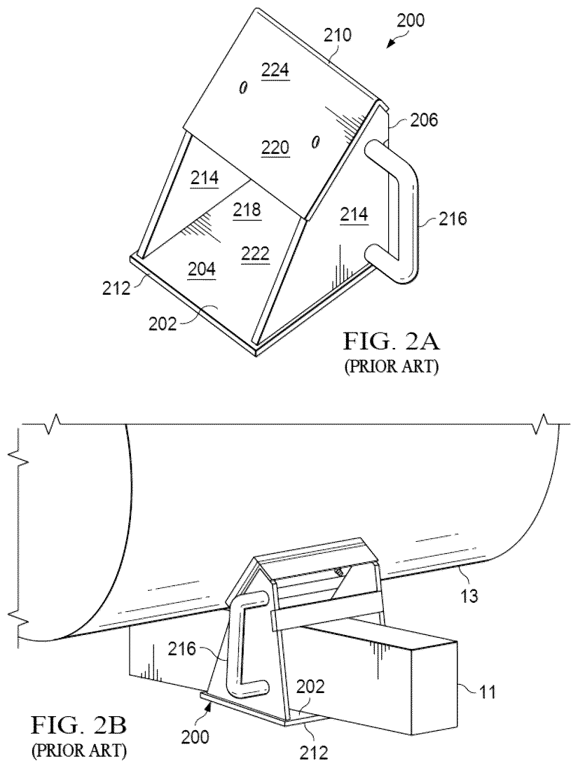

### DETAILED DESCRIPTION OF THE INVENTION

The invention provides a novel metal chock design wherein the chock generally comprises a wedge that is preferably as wide as the dunnage, and from which downwardly depends a single dunnage attachment surface, preferably protruding forward from the wedge, but not necessarily so. The wedge may be a straight line wedge, or the upper surface may be curved to fit particular pipes.

Preferably, the chock is cut as a single piece out of sheet metal, bent on four lines and then welded on 4 lines to form a 3D strong chock that has been successfully tested up to 5000 lbs. A curved wedge, however, will require at least three pieces to accommodate the curved top surface of the wedge. In other variations, the hollow wedge of the chock can be strengthened with baffles, or the wedge may be a solid chuck of metal.

Although we prefer the chock is made of metal since our concern relates to heavy metal pipes, a resin chock may be suitable for lighter loads, such as PVC pipes. Thus, the same design principles may be applied to a resin chock.

In preferred embodiments, the chock has a 0.25-1 inch piece of resin, such as nylon, that is screwed, bolted or glued to the top of the wedge. This prevents metal-to-metal contact and is beneficial to protect coated pipes. Preferably the device uses screws or bolts added before wedge welding is completed, but the heads are inset (countersunk) and covered with additional resin or a resin cap so that the metal of the screw head cannot contact the pipe, but it may also be possible to use a plastic fastener or even a strong adhesive, such as epoxy. In a preferred option, however, the nylon covers the top and at least a portion of the triangular sides of the wedge, and the nylon is bolted on the sides, rather than the top. Since the sides never contact the pipe, this is the safest alternative where metal fasteners are used.

In yet other embodiments, the chock itself is coated with a resin or rust preventive coating, and this may be applied by spraying or dipping, and the like.

The size of the pipe chock will of course vary with the application, and we anticipate making two, three or more different sizes. Thus, downhole tubulars in the range of 2-4 inches diameter might use a small 5″ chock. Casing pipes up to 13-15″ might use a medium chock of about 8″. Large concrete pipes for drainage applications or large pipes used to make reactors and tanks, however, may need a significantly larger chock of 12-24″.

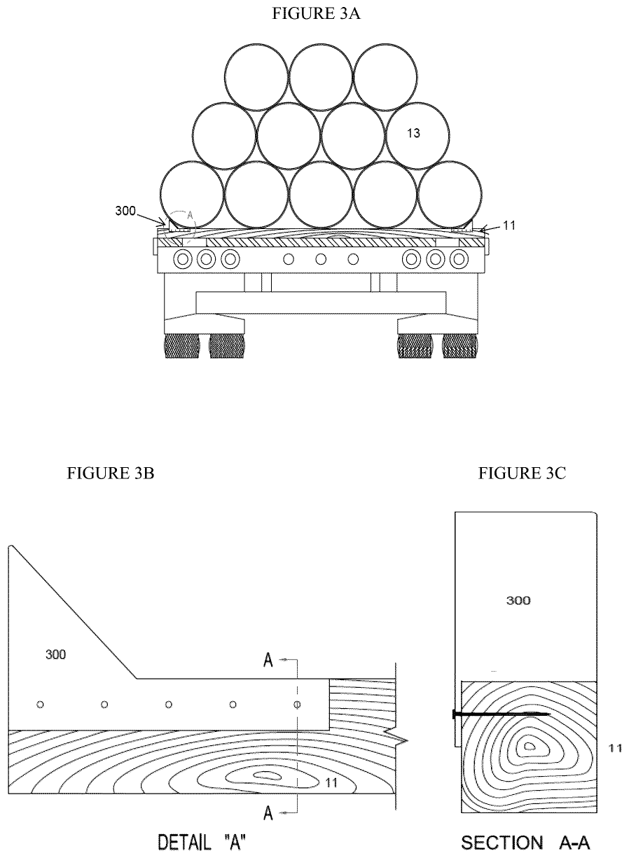

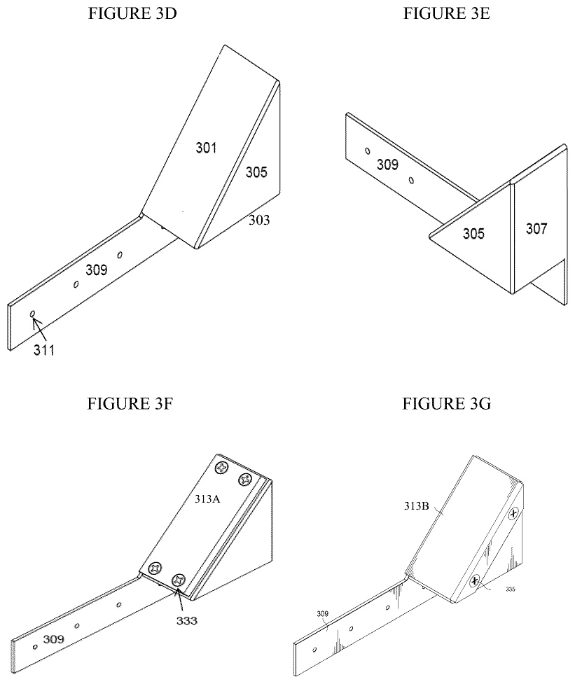

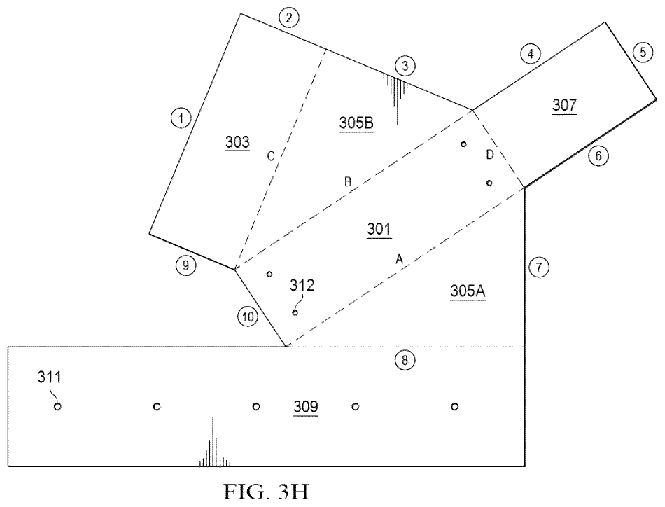

In more detail, the chock is described in FIG. 3. In FIG. 3A we see the chock 300 on dunnage 11 and supporting pipes 13 in this rear view of a flatbed trailer. It can also be seen in more detail in FIG. 3B and in cross section at line A-A at FIG. 3C. A plurality of similar dunnage/chock combinations are used along the length of the pipe (not shown).

In FIGS. 3D and 3E the chock 300 has a pipe securing wedge or right triangular prism formed from pipe support top surface 301, base or bottom 303, two triangular sides 305, and back 307. Downwardly depending from one triangular side of the wedge is the dunnage securing surface 309 with holes 311 for fasteners, such as screws or nails. The same parts are shown from different angles in 3D and 3E.

In the embodiment of FIG. 3F, we also see optional resin layer 313A secured to pipe support surface via fasteners 333, in this case screws, but rivets, bolts, adhesive or other fasteners may be used. The resin layer allows the chock to be used with coated pipe, protecting the coating from direct metal-to-metal contact. The resin may be nylon, polyethylene, especially high-density polyethylene, polyvinyl chloride, and the like. However, nylon was used in the prototypes. It is also possible to coat the entire device with resin or a rust-proofing layer, but the use of stainless steel or aluminum may obviate the need for rust proofing.

Where fastened at the top with metal fasteners 333, they should be countersunk and coated with resin or a resin cap to prevent metal fasteners from touching coated pipe. However, FIG. 3G shows another possibility where the nylon layer 313B is attached via fasteners 335 along the sides of the wedge, rather than the top. This embodiment is preferred as avoiding possible contact with screws when the resin layer wears with repeated use.

In FIG. 3H, there is one pattern for the device of FIG. 3A-F laid out flat. Thus, the entire device may be built from a single sheet of metal, although if preferred more than one piece of metal may be used. This may be preferred because there will be less wastage of the sheet metal, plus it is a requirement for making a curved wedge.

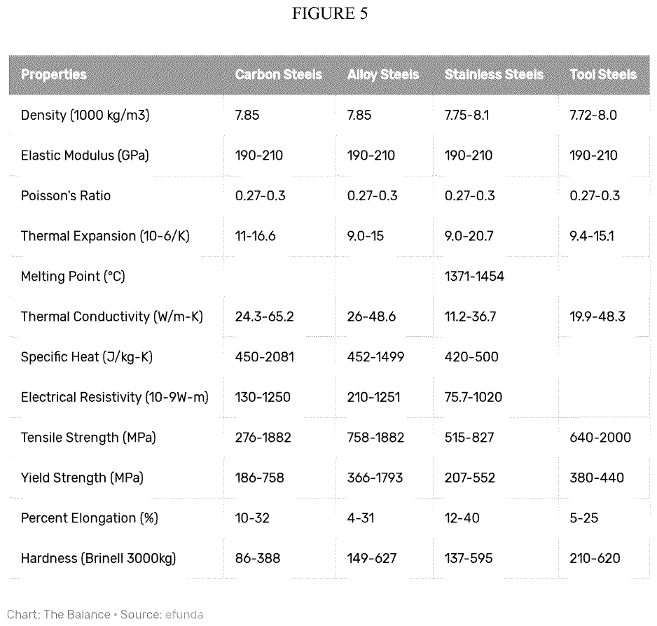

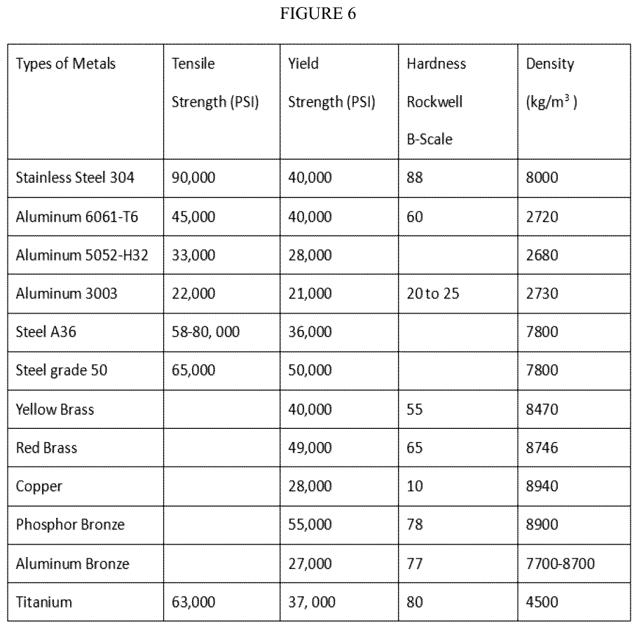

To manufacture a hollow wedge chock, a sheet of metal that is about 2-5 mm thick is cut into the indicated shape from FIG. 3H. Preferably cold rolled alloy steel is used, but other steels may be used, including stainless, alloy, carbon and tool steels. See FIG. 5 for the properties of various steels. In our prototypes, we used 3 mm sheet of cold rolled steel. Aluminum and other metals could also be used, provided there is sufficient strength for the intended application. See FIG. 6.

Once the pattern is cut out, the metal is bent to form 90° angles at each of fold lines a, b, c, and d. Then the welding occurs, for example line 1 is welded to line 8, line 9 to 10, line 3 to 4, line 2 to 5, and line 6 to 7. The order is not essential, and thus the order of bending and welding steps may vary.

With these welds a hollow right triangular prism is formed that is fully enclosed. The wedge consists of top surface 301 supporting the pipe 313 (not shown), and fastener holes 312, a bottom surface 303 resting on the upper side of the dunnage 311. Dunnage attachment surface 309 downwardly depends from (and is contiguous with) one triangular side surface 305 and allows for securing the chock 300 to the side of the dunnage 311 as seen in FIG. 3C. Since the dunnage attachment surface 309 lies under and forward of the wedge, no dunnage space is wasted. Further, since there is only a single dunnage attachment flange, installation is easy and there is never a problem with a difficult fit.

The embodiments of FIG. 3A-H have straight edges and are thus suitable for use with any pipe diameter. However, it is also possible to make the pipe support surface curved to fit a particular sized pipe, which may be of benefit for certain applications.

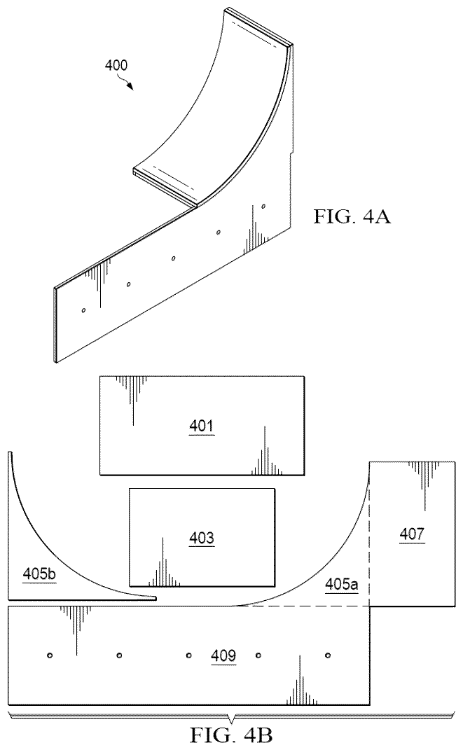

FIG. 4A shows a side perspective view of a pipe chock 400 that has a curved pipe support top surface, and FIG. 4B shows one possible pattern for cutting the metal for this embodiment. Thus, we see chock 400 including top 401, bottom 403, generally triangular sides 405a and 405b with curved hypotenuse, back 407 and dunnage attachment surface 409. In this pattern, bottom 403 is a separate piece, but it could also be included with side 405b. Side 405a, back 407 and dunnage attachment 409 are cut as a single piece. Other patterns are also possible.

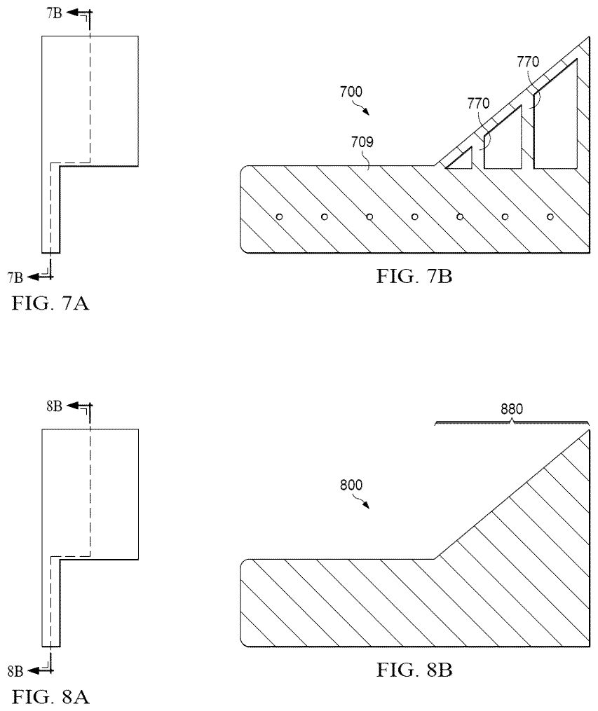

While aluminum or brass and other soft metals are not recommended for a hollow chock intended to be used for 50,000-pound pipe loads, one or more inside baffles may be used to increase the chocks strength, or alternatively a solid metal wedge, rather than a hollow wedge, could be used. FIG. 7A-B illustrates an offset cross-sectional view along line 7B-7B of a chock 700 wherein two vertical baffles 770 can be seen inside the wedge above dunnage attachment surface 709. FIG. 8A-B shows a solid chock where the wedge 880 is a solid chunk of metal, not hollow. In this embodiment, the dunnage support element will typically need to be welded, screwed, or bolted to the solid wedge, and thus that component may be cut in a shape similar to that shown in FIG. 8B, the solid wedge attached behind the triangular portion of that shape.

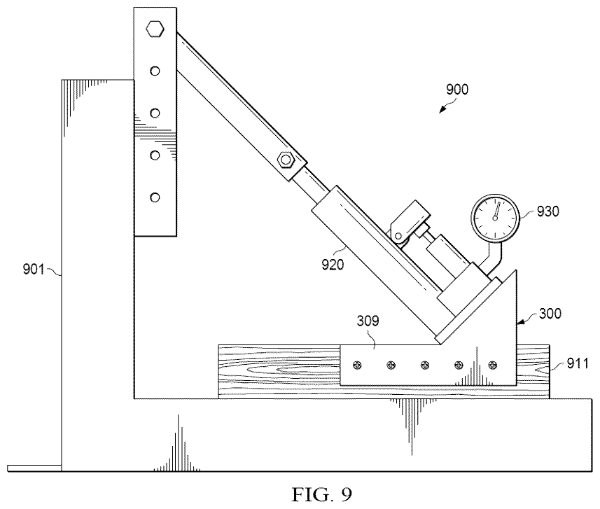

We have tested a prototype of the pipe chock made with 3 mm, or ⅛ inch cold rolled steel, and compared it against the prior art resin pipe chock as well as home-made wooden chocks. There is no applicable ASTM for pipe chocks, so we designed and built an apparatus that would test a chock's strength resistance to lateral movement as well as its ability to remain in a fixed position while under load. The test apparatus 900 is shown in FIG. 9.

The apparatus 900 is designed with a primary ram 920 fitted with a gauge 930 that measures force up to 5,000 pounds. The ram applies force at an angle to mimic rolling momentum. The apparatus is designed with a sample piece of dunnage 911.

In more detail, wood dunnage 911 is bolted to base of the test machine bracket structure 901. The chock 300 to be tested is attached to dunnage via dunnage attachment surface 309. A calibrated hydraulic jack 920 simulates the force of pipe tending to roll against the chock. The force applied is read from the gauge 930. The force can be applied at different angles and mimics rolling momentum, and force at failure recorded.

Testing at 45° showed that the resin (plastic) chock and homemade wooden chocks both fail well below 1000 pounds of pressure, but our 3 mm metal prototype withstood 5000 pounds, although there was a small amount of deformation of the wedge. Thus, we believe that our device will withstand thousands of uses at 4500 pounds or more, and with thicker steel, better alloys, adding baffles or switching to a solid wedge this can be improved even further.

The following references are incorporated by reference in their entirety for all purposes.
U.S. Pat. No. 4,190,165 Pipe chock stick
U.S. Pat. No. 4,729,537 Pipe-chock
U.S. Pat. No. 10,549,676 Support chock
U.S. Pat. No. 11,479,217 Wheel chock and method

1) A pipe chock, said pipe chock comprising:
a) a pipe support having a generally right triangular prism shape with an upwardly angled top, a bottom, a back, a first triangular side and a second triangular side;
b) a single dunnage attachment member downwardly depending from said first triangular side;
c) said dunnage attachment member having holes therein for fastening said pipe chock to a side surface of a separate dunnage; and
d) said top supporting a separate tubular member when in use.

2) The pipe chock of claim 1, wherein said pipe chock comprises a metal selected from alloy steel, carbon steel, tool steel, or stainless steel.

3) The pipe chock of claim 2, wherein said pipe chock is metal and said metal pipe chock or a portion thereof is coated with an anti-rust or resin coating.

4) The pipe chock of claim 2, wherein said pipe chock is cut as a single piece from a sheet of metal and formed by bending and welding said cut sheet.

5) The pipe chock of claim 2, wherein said pipe chock is cut as a plurality of pieces from a sheet of metal and formed by bending and/or welding one or more of said plurality of pieces.

6) The pipe chock of claim 2, wherein said top further comprises a layer of resin on an upper surface of said top.

7) The pipe chock of claim 2, wherein said top further comprises a 0.25-1 inch layer of resin on an upper surface of said top, said resin selected from high-density polyethylene (HDPE) or nylon.

8) A metal pipe chock, said pipe chock comprising:
a) a metal pipe support having a generally right triangular prism shape with a top, a bottom, a back, a first triangular side and a second triangular side;
b) said bottom having a front end and a back end opposite said front end and contacting said back;
c) said bottom sized to fit a width of a separate dunnage;
d) a single metal dunnage attachment member downwardly depending from said first triangular side and protruding beyond said front end of said bottom;
e) said dunnage attachment member having holes therein for fastening said pipe chock to a side of said separate dunnage; and
f) said top supporting a separate tubular member when in use.

9) The pipe chock of claim 8, wherein said top further comprises a layer of resin on an upper surface of said top.

10) The pipe chock of claim 8, wherein said top further comprises a 0.25-1 inch layer of resin on an upper surface of said top, said resin selected from high-density polyethylene (HDPE) or nylon.

11) The pipe chock of claim 8, wherein said metal is selected from alloy steel, carbon steel, tool steel, or stainless steel.

12) The pipe chock of claim 8, wherein said pipe chock or a portion thereof is coated with an anti-rust or resin coating.

13) The pipe chock of claim 8, wherein said pipe chock is cut as one or more piece(s) from a sheet of metal and formed by bending and welding said cut one or more piece(s).

14) The pipe chock of claim 8, wherein said pipe chock is cut as a plurality of pieces from a sheet of metal and formed by bending and/or welding one or more of said plurality of pieces and wherein said first triangular side and said second triangular side each has a curved hypotenuse and said top is curved.

15) The pipe chock of claim 8, wherein said generally right triangular prism shape is a fully enclosed hollow shape.

16) A metal pipe chock, said pipe chock comprising
i) a generally right triangular prism shaped metal wedge component sized to fit over a separate dunnage and
ii) a single metal dunnage attachment surface downwardly depending from said wedge component and integral with a side surface of said wedge and having attachment means thereon for attaching to a side of said separate dunnage.
